(19) United States
(12) Patent Application Publication
(10) Pub. No.: US 2022/0317315 A1
(43) Pub. Date: Oct. 6, 2022

(54) ALL SOURCE POSITION, NAVIGATION, AND TIMING

(71) Applicant: BAE SYSTEMS Information and Electronic Systems Integration Inc., Nashua, NH (US)

(72) Inventors: David M. Cooper, New York, NY (US); Wayne W. Altrichter, Chatham, NJ (US); Aaron W. Bennett, Merrimack, NH (US); Matthew J. Sherman, Succasunna, NJ (US)

(73) Assignee: BAE SYSTEMS Information and Electronic Systems Integration Inc., Nashua, NH (US)

(21) Appl. No.: 17/222,049

(22) Filed: Apr. 5, 2021

(51) Int. Cl. G01S 19/47; G01C 21/16; G01C 21/20

(52) U.S. Cl. CPC G01S 19/47; G01C 21/165; G01C 21/20; H04K 3/25

(57) ABSTRACT

The system and method for position, navigation, and timing and more particularly to a system that is time and/or position independent and capable of autonomous transition from GPS to non-GPS navigation. The integrated position, navigation, and timing system uses primary and secondary navigation sensors and primary and secondary navigation measurement sources with a common time reference architecture, an integrated “dual-grid” navigation module, an integrated “dual-grid” navigation Kalman filter, and an integrated “dual-grid” navigation source selection module to provide both geodetic and relative grid timing and/or location among members of a network of platforms, particularly in GPS denied or degraded environments.

### STATEMENT OF GOVERNMENT INTEREST

This disclosure was made with United States Government support under Contract No. 18-D-0112/18-F-2502 awarded by a Classified Agency. The United States Government has certain rights in this disclosure.

### FIELD OF THE DISCLOSURE

The present disclosure relates to a system for position, navigation, and timing and more particularly to a system that is time and/or position independent and capable of autonomous transition from GPS to non-GPS navigation.

### BACKGROUND OF THE DISCLOSURE

Military operations have grown increasingly reliant on the availability of geodetic positioning and timing through GPS for the exchange, processing, and action upon information created by any unit operating within a network. The exchange of sensor measurement and/or track data within the network can be used for a variety of applications including the creation and maintenance of a common track picture, local and network-wide command and decision processing, and local and network-wide engagement planning and execution. The desired result is to use commonly referenced information for situational awareness, and to make better decisions and to execute those decisions more efficiently and effectively.

The degree to which any of this functionality can be properly and effectively discharged is highly dependent on the accuracy of the data being exchanged and the ability to combine or fuse that data in a coherent fashion. If common time and navigation capabilities are not available, then a number of problems will arise in the network and the quality of the data exchange using improperly registered navigation and sensor measurements may vary from poor to unusable or worse. This is particularly the case when one or more platforms in the network are operating without GPS thus resulting in an increasing trend of time and navigation errors. Other errors that can arise from poorly aligned data include improper tactical identification (IDs) of targets, inaccurate raid counts, missed sensor cues, poor engagement execution, and the like.

Wherefore it is an object of the present disclosure to overcome the above-mentioned shortcomings and drawbacks associated with the conventional position, navigation, and timing systems.

### SUMMARY OF THE DISCLOSURE

One aspect of the present disclosure is a system comprising an integrated position, navigation, and timing system, comprising: a common time reference architecture; an integrated dual-grid navigation module; an integrated dual-grid navigation Kalman Filter; and an integrated dual-grid navigation source selection module, wherein the system is configured to provide both absolute geodetic and relative grid time and/or location information to a plurality of platforms in a network via a platform distributed position, navigation, and timing system and a communications system.

One embodiment of the system is wherein the system is functional in GPS denied and GPS degraded environments.

Another embodiment of the system is wherein the common time reference architecture comprises a high precision time and frequency system. In some cases, the platform distributed position, navigation, and timing system provides a local airborne, shipboard, or ground-based solution. In certain embodiments, the communication system provides for distribution of the platform position, navigation, and timing solution to other platforms in the network.

Yet another embodiment of the system is wherein the system inputs include data from primary and secondary navigation sensors and primary and secondary measurement sources. In some cases, primary navigation sensors include INS (inertial navigation system). In certain cases, primary navigation measurement sources include GPS.

Still yet another embodiment of the system further comprises the use of an LPD/LPI/LPE (low probability of detection, intercept, or exploitation, respectively) navigation waveform with the communication system. In certain embodiments, the integrated dual-grid navigation source selection module in connection with the integrated dual-grid navigation Kalman Filter determines, from all available measurement sources, measurements that provide the best geometric distribution and minimum covariance for both geodetic and relative grid processing.

Another aspect of the present disclosure is a method of integrated position, navigation, and timing, comprising: receiving navigation sensor and navigation measurement source data from both local platform data and remote communication network data via an integrated position, navigation, and timing system, the system comprising: a common time reference architecture; an integrated dual-grid navigation module; an integrated dual-grid navigation Kalman Filter; and an integrated dual-grid navigation source selection module; determining from all available navigation sensor data and navigation measurement sources, which sensor data and which measurement sources provide the best geometric distribution and minimum covariance for both geodetic and relative grid processing; providing a local airborne, shipboard, or ground-based solution via a platform distributed position, navigation, and timing module; and distributing the platform position, navigation, and timing solution to other platforms in the network via a communications system; thereby providing relative time and/or location information to a plurality of platforms in a network in GPS denied and GPS degraded environments.

One embodiment of the method is wherein the common time reference architecture comprises a high precision time and frequency system. In some cases, the platform distributed position, navigation, and timing system provides a local airborne, shipboard, or ground-based solution.

Another embodiment of the method is wherein the communication system provides for distribution of the platform position, navigation, and timing solution to other platforms in the network.

Yet another embodiment of the method is wherein the system inputs include data from primary and secondary navigation sensors and primary and secondary measurement sources. In some cases, primary navigation sensors include INS and primary navigation measurement sources include GPS.

Still yet another embodiment of the method further comprises the use of an LPD/LPI/LPE (low probability of detection, intercept, or exploitation, respectively) navigation waveform with the communication system. In certain embodiments, the integrated dual-grid navigation source selection module in connection with the integrated dual-grid navigation Kalman Filter determines, from all available measurement sources, measurements that provide the best geometric distribution and minimum covariance for both geodetic and relative grid processing.

Yet another aspect of the present disclosure is an integrated position, navigation, and timing system, comprising: a common time reference architecture comprising a high precision time and frequency system; an integrated dual-grid navigation module; an integrated dual-grid navigation Kalman Filter; and an integrated dual-grid navigation source selection module, wherein the system is configured to provide both absolute geodetic and relative grid time and/or location information to a plurality of platforms in a network in GPS denied and GPS degraded environments via a platform distributed position, navigation, and timing system and a communications system. In certain embodiments, the system further comprises the use of an LPD/LPI/LPE (low probability of detection, intercept, or exploitation, respectively) navigation waveform with the communication system.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a diagram of one embodiment of an integrated or all source position, navigation, and timing (PNT) system of the present disclosure.

FIG. 2 is a detailed diagram of one embodiment of an integrated or all source position, navigation, and time (PNT) solution according to the principles of the present disclosure.

FIG. 3A is a diagram of one embodiment of a common time reference architecture (CTRA) of an embodiment of the integrated or all source position, navigation, and timing (PNT) system of the present disclosure.

FIG. 3B is a detailed diagram of one embodiment of a common time reference architecture (CTRA) of an embodiment of the integrated or all source position, navigation, and timing (PNT) system of the present disclosure.

FIG. 4 is a concept of operation diagram of one embodiment of the integrated or all source position, navigation, and timing system of the present disclosure in use with a communication system for distributing/exchanging position report messages within a network of platforms.

FIG. 5 is a flowchart of one embodiment of a method of using an integrated or all source position, navigation, and timing system of the present disclosure.

FIG. 6A and FIG. 6B are plots of one embodiment of an LPD/LPI/LPE (low probability of detection, intercept, or exploitation, respectively) navigation waveform in time domain view and in frequency domain view, respectively, according to the principles of the present disclosure.

FIG. 7 is a plot of navigation performance for one embodiment of an integrated or all source position, navigation, and time solution according to the principles of the present disclosure.

### DETAILED DESCRIPTION OF THE DISCLOSURE

The exchange of sensor measurement and/or track data within a network can be used for a variety of applications including the creation and maintenance of a common track picture, local and network-wide command and decision processing, and local and network-wide engagement planning and execution. By using commonly referenced information for situational awareness, it is possible to make better decisions and to execute those decisions more efficiently and effectively.

The degree to which any of this functionality can be properly and effectively discharged is highly dependent on the accuracy of the data being exchanged within the network and the ability to combine or fuse that data in a coherent fashion. To a large extent, this accuracy will be dictated by the degree to which the data from each of the participating platforms in the network can be aligned and brought into common temporal and spatial reference frames. If the alignment is done well, then the synergies commonly claimed for networked systems can be realized; if done poorly, then the result may well be worse than if no data were exchanged at all. Hence, the use of a common time and navigation capability across multiple warfighting platforms in a network, as described herein, is used for the coherent exchange of data.

If common time and navigation capabilities are not available, then a number of problems arise in the network and the quality of the data exchange using improperly registered navigation and sensor measurements may vary from poor to unusable or worse. This is particularly the case when one or more platforms in the network are operating without GPS thus resulting in an increasing trend of time and navigation errors. If the network navigation errors result in very poorly aligned data among platforms, then it may be impossible to associate measurements of the same object with a single track, resulting in multiple copies of a track for a single object (i.e., redundant tracks). If the data are well enough aligned to associate with the same track, but still not well aligned, then the accuracy of the resulting track may not be adequate for the purposes for which it is intended (e.g., fusion, decision-making, and engagement). Other errors that can arise from poorly aligned data include improper tactical identification (IDs) of targets, inaccurate raid counts, missed sensor cues, poor engagement execution, and the like.

One embodiment of the present disclosure is a system configured to provide position and navigation functionality that autonomously transitions from GPS navigation (e.g., WGS 84) to non-GPS navigation (i.e., Integrated PNT system with “Dual-Grid” WGS-84 geodetic and relative navigation) as described herein. In certain embodiments, the system further provides synchronized timing throughout the system and network.

These PNT capabilities enable mission systems' operations, such as passive targeting, improved communication, improved engagements and fire control, and improved Electronic Warfare that are dependent on accurate position and time within the network of platforms. In one embodiment, a navigation processor running both GPS navigation and non-GPS navigation is integrated with a precision clock and an LPD/LPI/LPE (low probability of detection, intercept, or exploitation, respectively) navigation waveform. In some cases, a library of navigation sensors and measurement sources are also included.

The DoD time standard is Coordinated Universal Time (UTC) as provided by the U.S. Naval Observatory (USNO) and is referred to as UTC(USNO). The DoD geospatial standard is the World Geodetic System—1984 (WGS-84) as established by the National Geospatial-Intelligence Agency (NGA). The primary dissemination of these temporal and geospatial references is provided by the Global Positioning System (GPS). A primary concern for today's warfighter is the development of alternate or secondary UTC time and WGS-84 navigation sources that can be provided during periods when GPS is denied or degraded.

It is understood that the vulnerabilities of GPS-based systems are increasing as is a dependency on GPS-based timing and navigation. Thus, it is important to develop non-GPS navigation and timing approaches and to apply these techniques to mission systems which will be described in more detail herein. The present approach of navigation and timing in the absence of GPS enables mission systems to continue operating in a GPS-denied environment. In certain embodiments, this includes situation awareness, location information about friendly and hostile forces, integrated fire control, precision guided munitions guidance, passive targeting, and the like.

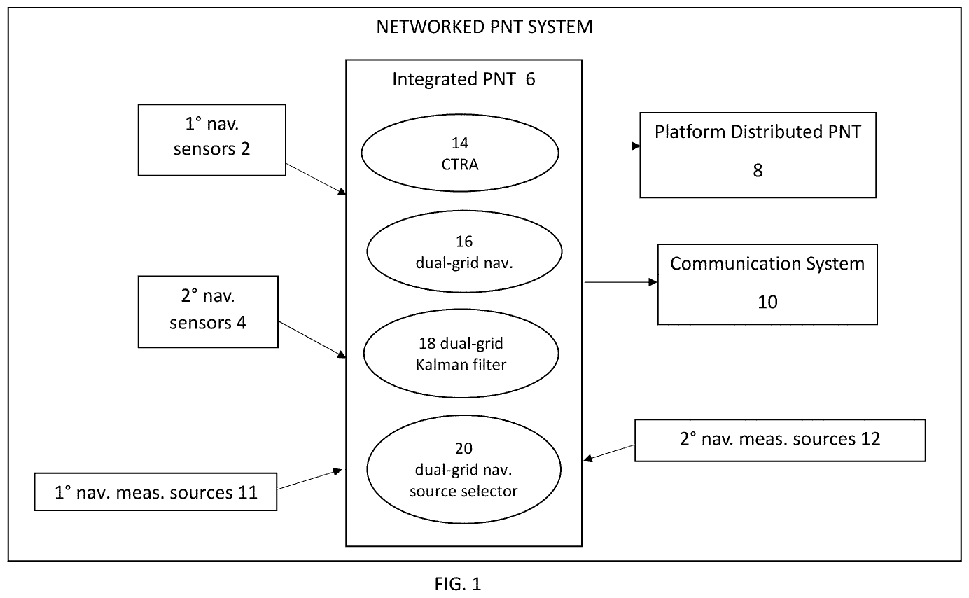

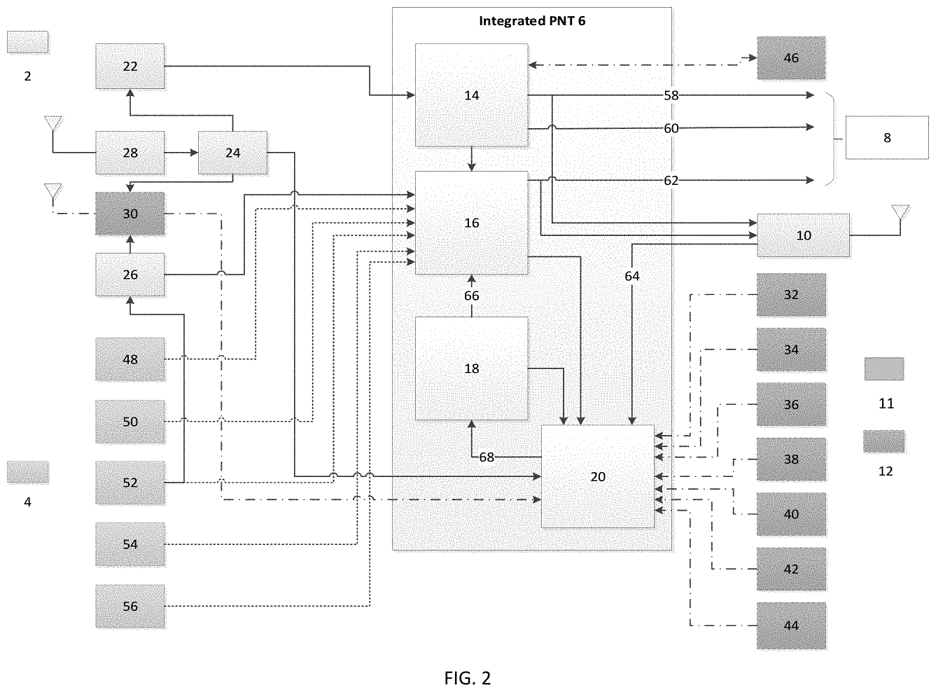

Referring to FIG. 1, a diagram of one embodiment of the integrated or all source position, navigation, and timing (PNT) system of the present disclosure is shown. More specifically, a networked PNT system is useful for coordinating platforms in need of accurate position, navigation, and time information. In one example, this is a network of various airborne, shipboard, and ground-based platforms. This figure is a simplified version of FIG. 2. Each networked platform PNT system comprises primary navigation sensors 2 (e.g., INS) and secondary navigation sensors 4 (e.g., Doppler) that feed data to an integrated PNT system 6. Each networked platform PNT system also comprises primary navigation measurement sources 11 (e.g., GPS) and secondary navigation measurement sources 12 (e.g., Link 16, Stellar, Imaging) that provide position and/or velocity measurements to an embodiment of the Integrated PNT system 6.

Still referring to FIG. 1, in some cases a communication system 10 provides for transmission and reception of position report messages with received message time-of-arrival (TOA) range measurements that also feed data into the integrated PNT system 6. In certain embodiments, the primary navigation sensors may include an inertial navigation system (INS), or the like. In certain embodiments, the secondary navigation sensors 4 may include Doppler, communication navigation waveforms, or the like. In certain embodiments, the primary navigation measurement sources 11 may include GPS, or the like. In certain embodiments, the secondary measurement systems 12 may include Link 16, stellar positioning, laser range measurements, terrain navigation positioning, or the like.

One embodiment of a common time reference architecture (CTRA) 14 is based on using a High Precision Time and Frequency System (HPTFS), or the like, as a master reference for each networked platform. The HPTFS, or the like, accepts time inputs from GPS (or alternate sources) as available and has frequency accuracy and stability to maintain time with sub-nanosecond accuracy over long periods even in the absence of GPS.

It is to be understood that a number of different clock architectures exist and the timing and frequency performance of the clock (e.g., HPTFS) is architecture dependent. Architecture types most likely to be used in the present disclosure have performance ranges from tens of nanosecond accuracy (more mature architecture—e.g., a flash-lamp based clock) to sub-nanosecond (less mature architectures—e.g., a Pulse Optically Pumped (POP) clock). In general, a higher performance clock (higher accuracy) is better for the system of the present disclosure because navigation accuracy is dependent on (among other things) timing accuracy, e.g., TOA range measurements derived from GPS or the Communication System.

Still referring to FIG. 1, in certain embodiments the secondary navigation sensors 4 may include Inertial Measurement Unit (IMU), air speed, Doppler velocity, acceleration, altitude, angular sensors, or the like. In certain embodiments, the secondary measurement sources 12 may include Link 16, stellar sensors, terrain navigation, imaging sensors, very low frequency (VLF) PNT, RADAR, laser ranging, signals of opportunity (SOP), host secondary time and frequency sources, or the like. One embodiment of the Integrated PNT 6 comprises a common time reference architecture 14, an integrated “dual-grid” navigation module 16, an integrated “dual-grid” navigation Kalman filter 18, and an integrated “dual-grid” navigation source selection module 20. These modules will be discussed in more detail below.

Certain embodiments of the Integrated PNT system 6 feed data to a platform distributed PNT system 8 and a communication system 10. In certain embodiments, the communication system 10 is a directional communication system. In some cases, the platform distributed PNT system 8 comprises time and frequency information; host time and frequency error estimates; and position, velocity, acceleration, and attitude information.

One embodiment of the communication system 10, or network, incorporates the exchange of timing information (measurements) among network participants, such as round-trip timing or two-way timing messaging, to ensure common time throughout the network. This level of timing accuracy supports accurate range determination using time-of-arrival (TOA) measurements for navigation and accurate time-difference-of-arrival (TDOA) for geo-location applications, for example.

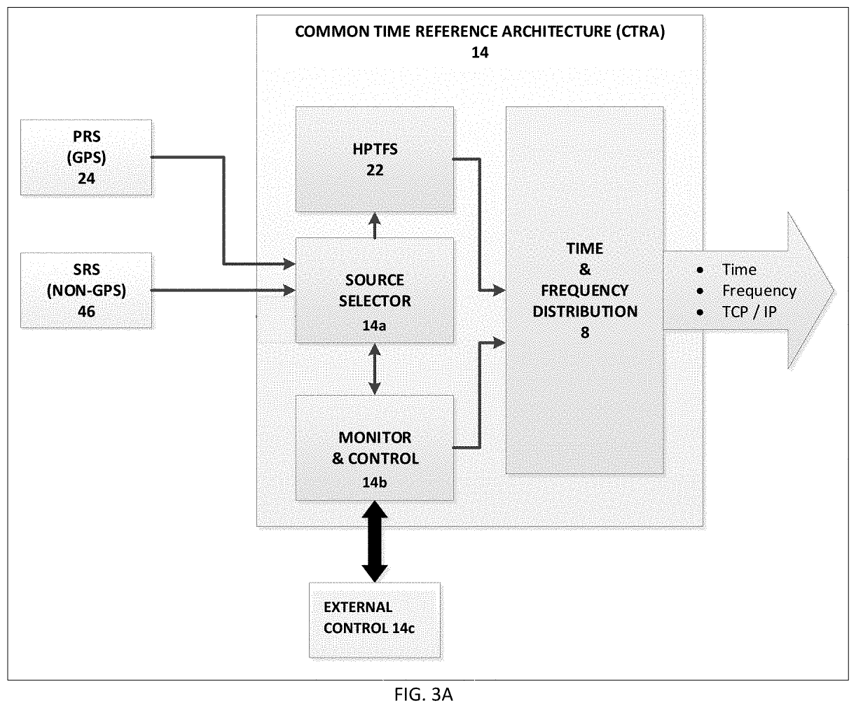

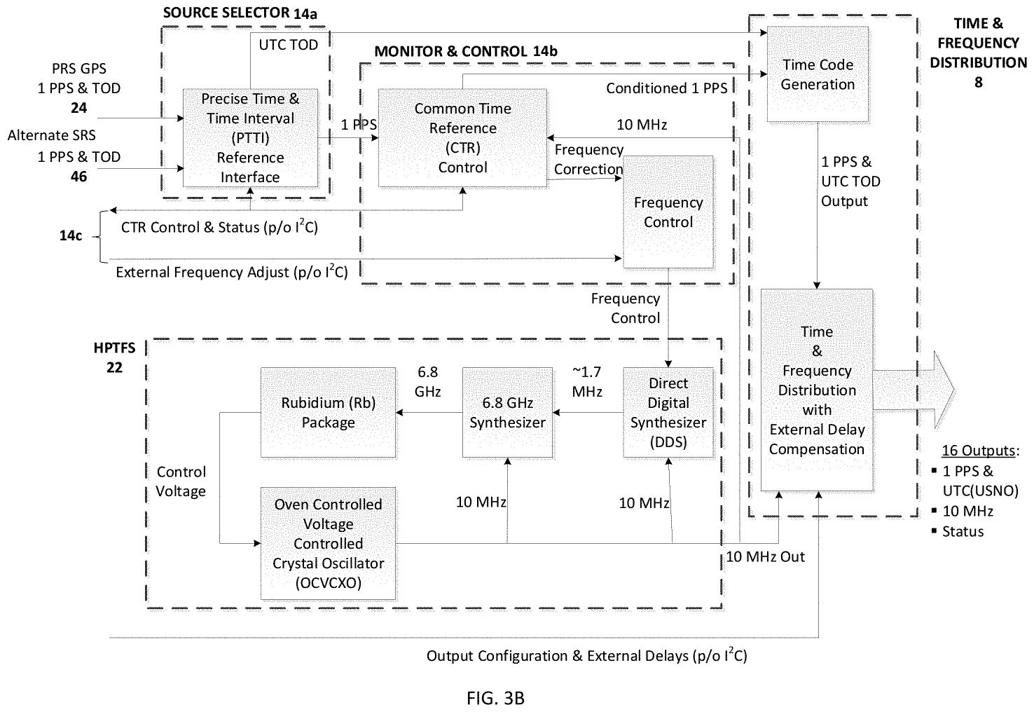

Referring to FIG. 2, a detailed diagram of one embodiment of an integrated or all source position, navigation, and timing (PNT) solution according to the principles of the present disclosure is shown. More specifically, each networked platform PNT system comprises primary navigation sensors 2. In some cases, secondary navigation sensors 4 also feed data to the Integrated PNT system 6. In some cases, primary navigation measurement sources 11 and secondary navigation measurement sources 12 also feed data into the Integrated PNT system 6. In certain embodiments, the primary navigation measurement sources may include GPS 24 via a GPS anti jam antenna 28 as a measurement source; INS 26 as a primary navigation sensor, a High Precision Time and Frequency System (HPTFS) 22, or the like. One embodiment of a common time reference architecture (CTRA) 14 is based on using the HPTFS as a master reference for each platform. The HPTFS 22 accepts time inputs from GPS 24 (or alternate timing input source(s)) as illustrated in FIG. 3A and has frequency accuracy and stability to maintain time with sub-nanosecond accuracy over long periods in the absence of GPS.

In certain embodiments the secondary navigation sensors 4 may include IMU 48, speed 50, altitude 52, angular sensors 54, acceleration 56, or the like. In certain embodiments, the secondary measurement sources 12 may include Link 16 PNT 30, stellar sensors 32, terrain navigation 34, imaging sensors 36, very low frequency (VLF) PNT 38, RADAR 40, laser ranging 42, signals of opportunity (SOP) 44, host secondary time and frequency sources 46, or the like.

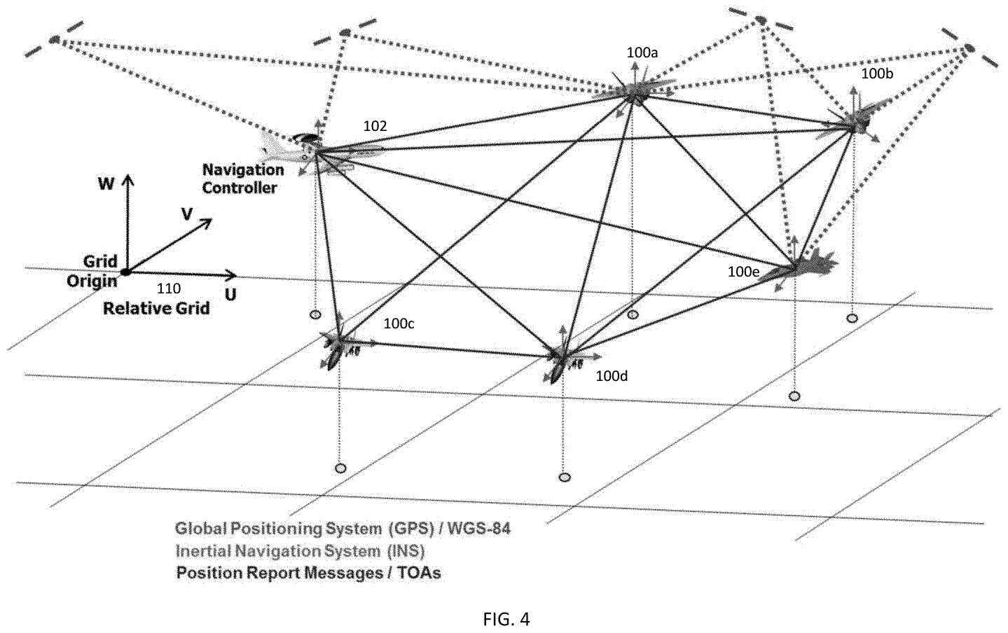

Still referring to FIG. 2, one embodiment of the Integrated PNT 6 comprises a CTRA 14, an integrated “dual-grid” navigation module 16, an integrated “dual-grid” navigation Kalman filter 18, and an integrated “dual-grid” navigation source selection module 20. Within one embodiment of the Integrated PNT 6 system, a common “dual-grid” navigation capability 16 provides simultaneous geodetic WGS-84 and relative grid navigation achieved by integrating all available navigation platform primary sensor data 2 and secondary sensor data 4 (e.g., INS 26, IMU 48, altimeter 52, etc.), with all available primary measurement sources 11 and secondary measurement sources 12 (e.g., GPS 24, range TOA 42, stellar 32, etc.). The list of navigation sensors and measurement sources is not meant to be exhaustive, and new sources may be added since the Integrated PNT 6 system and software is modular. Each platform's integrated “dual-grid” navigation module 16 solution data 62 is distributed among other units (or platforms) in the network by transmitting periodic position report messages with corresponding received TOA range measurements (e.g., communication system 10) to provide a network navigation capability as illustrated in FIG. 4.

In certain embodiments, the HPTFS 22 provides a master time and frequency reference source for the local platform. The CTRA 14 provides the distribution of time and frequency from the HPTFS 22 to all host platform clocks in the network to ensure both time synchronization and frequency synchronization with high accuracy and precision. The communication system(s) 10 provide round-trip timing and/or two-way transit protocols, for example, for the distribution and measurement of timing information throughout the network.

The integrated “dual-grid” navigation module 16 provides the necessary nonlinear mechanization equation implementation for each of the primary navigation sensor 2 and primary navigation measurement sources 11 and the secondary navigation sensor 4 and secondary navigation measurement sources 12 of the geodetic and relative grid navigation as a function of the available primary and secondary local navigation sensors, (e.g., INS, IMU, speed, acceleration, angular, etc.). For example, a primary INS with its accelerometer (delta-velocity) and gyroscope (attitude and attitude rates) data. One embodiment of an integrated “dual-grid” navigation module implements the inertial navigation equations required for position, velocity, misalignment, and attitudes. If additional secondary navigation sensor data are provided, the integrated “dual-grid” navigation module mechanizes and integrates the secondary navigation sensor data with the primary navigation sensor mechanization (e.g., Doppler velocity-damped INS). In addition, a relative Grid mechanizes the velocity of a navigation controller (a designated networked participant used as the relative grid reference) and combines it with local geodetic velocity information to establish a relative grid velocity for the platform. This relative grid velocity is integrated to produce a relative grid navigation solution for its local platform within the network.

The integrated “dual-grid” navigation module periodically accepts geodetic and relative grid error estimates 66 (corrections) from the integrated “dual-grid” navigation Kalman filter 18 (e.g., approximately every 2 seconds) to update the navigation mechanization states and integrate those corrections within the mechanization equations. This approach results in continuous geodetic and relative grid solutions with the latest corrections based on measurements processed by the Kalman filter. The integrated “dual-grid” navigation module provides both the geodetic and relative grid navigation solutions 62 with corresponding covariance data for each, which are distributed within the local platform 8 and for communication 10 to other network participants using position report messages.

Still referring to FIG. 2, the integrated “dual-grid” navigation source selection module 20 accepts all primary measurement sources 11 and secondary measurement sources 12 (e.g., GPS, Link 16 Precise Position Location Identification (PPLI) messages, communication position reports, stellar, terrain, etc.) as candidate measurement updates 68 in the integrated “dual-grid” navigation Kalman filter 18. The integrated “dual-grid” navigation source selection module 20 selects the latest covariance matrix from the integrated “dual-grid” navigation Kalman filter 18, which is used to determine, from the available primary and secondary measurement sources, which will provide the best geometric distribution and covariance (e.g., lowest error) for measurement sources as measurement updates in the integrated “dual-grid” navigation Kalman filter. The sources are selected independently for both geodetic and relative grid processing. The integrated “dual-grid” navigation source selection module 20 provides the integrated “dual-grid” navigation Kalman filter 18 with a monotonically increasing time-ordered set of measurement updates 68 for the next integrated “dual-grid” navigation Kalman filter cycle (e.g., approximately once per 2 seconds).

The integrated “dual-grid” navigation Kalman filter 18 models the specific error equations that correspond to the available primary 2 and secondary 4 navigation sensors. For example, for an INS the integrated “dual-grid” navigation Kalman filter 18 will include all the error state equations associated with an INS, e.g., position errors, velocity errors, misalignment errors, gyro errors, accelerometer errors. The integrated “dual-grid” navigation Kalman filter 18 also models the velocity errors of the relative grid navigation controller to estimate relative grid errors. The integrated “dual-grid” navigation Kalman filter 18 accepts the measurements from the integrated “dual-grid” navigation source selection module 20 each Kalman cycle and updates the error state vector for both geodetic and relative grid equations. At the end of each Kalman filter cycle, the integrated “dual-grid” navigation Kalman filter 18 provides its latest error state and covariance estimates to the integrated “dual-grid” navigation module 16 and the integrated “dual-grid” navigation source selection module 20.

The Integrated PNT system 6 feeds data to a platform distributed PNT system 8 and a communication system 10. In certain embodiments, the communication system 10 is a directional communication system. In some cases, the platform distributed PNT system 8 comprises time and frequency data 58; host time and frequency error estimates 60; and position, velocity, acceleration, and attitude information 62. The platform distributed PNT system 8 provides for the local platform (i.e., airborne, shipboard, or ground-based) utilization; whereas the communication system 10 is intended to provide for the distribution or exchange of the local platform PNT solution 58 and 62 to other communication network participants in the form of position report messages with TOA measurements, for example.

In certain embodiments, the integrated or all source navigation PNT executable software is run on processors using reduced instruction set computing architectures for computer processors, configured for various environments such field-programmable gate arrays (FPGAs) and general-purpose computers. In certain embodiments, the common time reference architecture (CTRA) is a component of the integrated or all source PNT system providing clock processing to enable best possible timing for PNT applications. In another embodiment, the system provides a PNT solution for RF navigation using a communication system with LPI/LPD/LPE waveforms on open systems hardware, which will be described in more detail below. In certain embodiments, the integrated or all source navigation PNT executable software is run on multiple platforms simultaneously with one being designated as the navigation controller (i.e., 102 of FIG. 4). The navigation controller can be assigned essentially arbitrarily and can be reassigned at a later time, e.g., if the airborne platform that was designated as navigation controller were to land then another still airborne platform would assume the role of navigation controller, which will be described in more detail below.

Referring to FIG. 3A, in one embodiment of the system of the present disclosure, the integrated or all source PNT system provides navigation and timing resilience for a network of platforms. In some cases, a CTRA and related software is used to optimize clock time/frequency performance, i.e., minimize time and frequency drift errors. This PNT architecture and software provides enhanced GPS-based timing in the absence of GPS using the alternate reference sources or secondary reference system 46 and the HPTFS 22. Here, output from primary and secondary reference systems 24, 46 are received by the source selector 14a, which is in communication with a high-precision time and frequency system (HPTFS) 22, or the like, acting as a master reference to establish and maintain accurate time and frequency data. Monitor and control 14b functions as well as external control functions 14c are also present in certain embodiments. The CTRA 14 feeds output to the distributed PNT 8 for providing accurate time and frequency data over TCP/IP, or the like, to various members of the network.

Referring to FIG. 3B, a detailed diagram of one embodiment of a common time reference architecture (CTRA) of the integrated or all source PNT system of the present disclosure is shown. More specifically, a common time reference architecture (CTRA) with a high-precision time and frequency system (HPTFS) 22 as a master reference may be used to establish and maintain accurate time and frequency. In one embodiment, the HPTFS 22 includes a rubidium atomic frequency reference combined with an oven-controlled crystal oscillator and accepts time inputs from GPS (or an alternate source) 24, 46 when available to provide frequency control with frequency accuracy and stability to maintain time with 20-30 nanosecond accuracy over long periods (e.g., >8 hrs) in the absence of GPS.

In one embodiment of the HPTFS 22, an integrated tactical atomic clock demonstrated 1 nS stability for an 8-hour mission with a low-risk path to sub 100 pS. In certain cases, the integrated tactical atomic clock is suitable for use in tactical temperature and vibration environments. One embodiment of a tactical atomic clock of the present disclosure has several benefits: it enables one-way broadcast ranging messages, which is a significant improvement over conventional pair-wise round trip timing messages (RTTs), and it enables coherent multi-platform techniques: e.g., geolocation, electronic attack, and the like.

Still referring to FIG. 3B, output from primary and secondary reference systems 24, 46 are received by the source selector 14a, which is in communication with a high-precision time and frequency system (HPTFS) 22, or the like, acting as a master reference to establish and maintain accurate time and frequency data. Monitor and control 14b functions as well as external control functions 14c are also present in certain embodiments. The CTRA 14 feeds output to the distributed PNT 8 for providing accurate time and frequency data over TCP/IP, or the like, to various members of the network.

Referring to FIG. 4, a diagram of one embodiment of the Integrated or All Source PNT system in use with a communication system 10 for distributing position report messages of the present disclosure is shown. More specifically, several platforms (100a-100e) are present in the “network” using the communication system 10 where each participant periodically transmits its position reports which includes both its geodetic and relative grid estimated positions and associated error covariance, valid at the time of transmission. In certain embodiments, not all network participants (or platforms) need direct access to GPS (in green) to achieve accurate geodetic WGS-84 navigation based on communication system 10 position reports from other participants that include, for example, a participant's geodetic location along with measured TOA (range measurement). The received position report and TOA are used as range line-of-sight measurement updates in the integrated “dual-grid” Kalman filter to estimate geodetic position error in the direction of the position report. All embodiments of the geodetic navigation of the present disclosure utilize the same WGS-84 coordinates used by Inertial Navigation Systems (INS) and by GPS.

Still referring to FIG. 4, a Relative Grid 110 provides an alternate, tangent to Earth ellipsoid plane, coordinate system, in which the precise exchange of each “networked” platform's navigation and sensor data (blue) occurs in a purely relative sense, that is, independent of accurate geodetic information. In certain embodiments, the network participants achieve accurate relative navigation with or without geodetic references (e.g., GPS) in the network using these same position reports and TOAs, based on the relative grid estimated position and associated error covariance. The relative grid embodiment requires one participant in the network to be designated as the navigation controller 102 which serves as the relative grid navigation reference platform by which all other participants estimate their respective relative locations using the received position reports. The relative grid coordinate system is established by a network participant designated as navigation controller (NC) 102 where its INS (in tan) provide the velocity reference axes by which all other relative grid participants align their respective velocity axes to achieve accurate relative position, velocity, and heading. This alignment process is analogous to participants performing inflight alignment of their respective INS to the INS of the NC using position report messages exchanged among all participants within communication system 10 network. The result is that target positions and other points of interest can be exchanged among network participants without significant loss of precision using relative grid navigation coordinates. The Relative Grid capability provides an accurate relative navigation reference system that may be used when geodetic sources are not available within the communication network, e.g., denied GPS.

In one embodiment of the system, an integrated “dual-grid” navigation capability provides simultaneous WGS-84 geodetic and relative grid navigation through the integration of available navigation sensor data (e.g., INS, Doppler, altimeter, etc.), with all available measurement sources (e.g., GPS, position report messages with both geodetic and relative grid range TOA, stellar, laser.) as illustrated in FIG. 2.

In certain embodiments, the Integrated PNT architecture of the present disclosure is provided as a modular software structure that allows for the addition of new navigation sensors (2, 4) and measurement sources (11, 12). In some cases, each platform utilizes the components of the Integrated PNT architecture that are applicable for its available systems. The Integrated PNT solution may be communicated among other platforms in a network using position report messages with TOA measurements, for example, thereby providing a distributed network navigation capability that is resilient in the absence of GPS. The integrated “dual-grid” PNT system ensures accurate relative navigation with or without geodetic references (e.g., GPS) within the communication network.

In one embodiment of the Integrated or All-Source PNT system of the present disclosure, inputs are accepted from multiple sensors. These various sensors are combined to provide a minimum variance error solution using the Integrated “Dual-Grid” Navigation Kalman Filter. In some cases, the Integrated or All-Source PNT system is embeddable in a host system or used as a second source navigation system when GPS is not available.

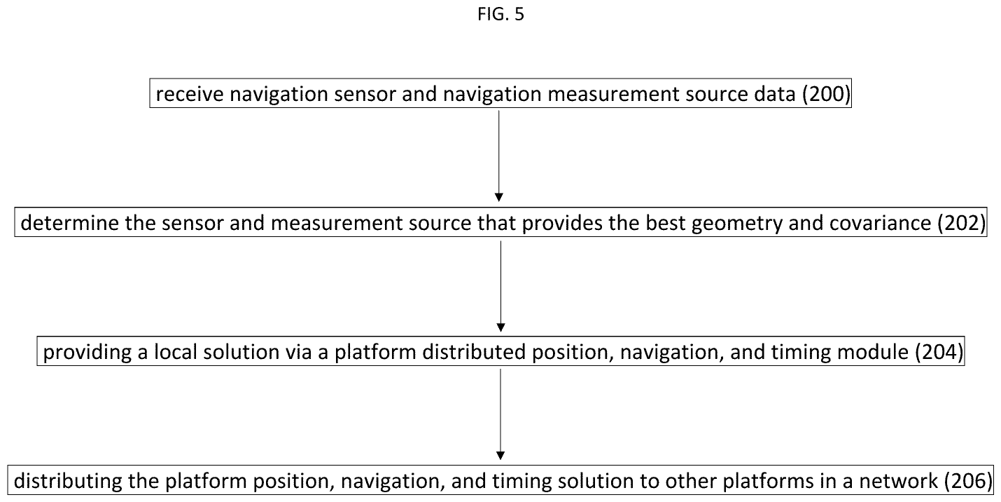

Referring to FIG. 5, a flowchart of one embodiment of a method of using an integrated or all source position, navigation, and timing system of the present disclosure is shown. More specifically, a method of integrated position, navigation, and timing, comprises receiving navigation sensor and navigation measurement source data from local platforms and remote communication network data via an integrated position, navigation, and timing system 200. In certain embodiments, the system comprises: a common time reference architecture; an integrated dual-grid navigation module; an integrated dual-grid navigation Kalman Filter; and an integrated dual-grid navigation source selection module. Next, from all available navigation sensor data and navigation measurement sources, it is determined which sensor data and which measurement sources provide the best geometric distribution and covariance for both geodetic and relative grid processing 202. A local airborne, shipboard, or ground-based solution is provided via a platform distributed position, navigation, and timing module 204. The platform position, navigation, and timing solution is provided to other platforms in the network via a communications system 206, thereby providing relative time and/or location information to a plurality of platforms in a network in GPS denied and GPS degraded environments.

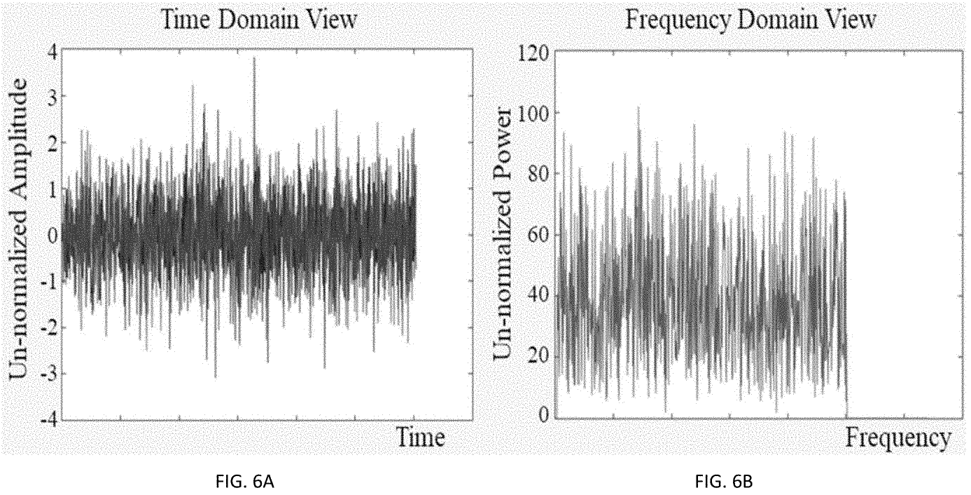

Referring to FIG. 6A and FIG. 6B, plots of one embodiment of a new LPD/LPI/LPE (low probability of detection, intercept, or exploitation, respectively) navigation waveform in the time domain view and in the frequency domain view, respectively, according to the principles of the present disclosure are shown. More specifically, one embodiment of the present disclosure uses the Link 16 waveform processing and occupies the Radio Navigation Spectrum (e.g., 900-1200 MHz). In some cases, the LPD/LPI/LPE (i.e., LPx) enabled system includes open architecture platforms, useable with a variety of radios. It is understood that the enemy can use existing waveforms to determine where a signal is originating from and attack. PNT waveforms that minimize this risk are therefore of great value in military scenarios.

One example of an LPx approach is a “chaotic” waveform (e.g., PHY) that can be integrated with a variety of waveforms. The primary goal of PHY is to approximate a Gaussian noise source so closely as to be indistinguishable from typical receiver noise. The signal uses rateless binary phase modulation of a wideband chaotic carrier. With appropriate filtering the waveform should be effectively featureless. Example time and frequency plots of the waveform are shown in FIG. 6A and FIG. 6B, respectively. FIG. 6A shows in phase (blue) and quadrature (red) components for a 3.2 microsecond pulse. Pulses have a variable size, and each is separately modulated. Statistically the pulses have an average length, but because each pulse is a different size the signal is “rateless” in that there is no constant signaling rate. Pulses may be distributed with gaps, or continually transmitted.

FIG. 6B shows the waveform is currently targeted for an average 250 MHz bandwidth, but the bandwidth of the carrier is also continuously varied along with the pulse width. In certain embodiments, the waveform is a “transform domain” wave form in that the frequency properties of the waveform are jointly managed with the time domain properties. So, for example, specific frequencies can be nulled, and other operations performed to deal with the impacts of Doppler etc. The carrier is “chaotic” in that it closely approximates a Gaussian noise source yet can be exactly recreated at destination receiver with the correct key. Of course, receivers without the correct key should not be able to distinguish the signal from typical receiver noise.

Ultimately the chaotic waveform will be a “parameterized” and operate at a range of bandwidth, pulse sizes, and nominal bit rates. In one embodiment, 250 MHz was the bandwidth of operation, but higher bandwidths and lower bandwidths are possible and can be configured within the cognitive framework. Other waveform modes can be used at data rates of about 1 Mbps.

It is intended that modulation be paired with a low-density parity-check code (LDPC) or other block code appropriate for low-rate communications that can operate at half rate or less. In information theory, a LDPC is a linear error correcting code, a method of transmitting a message over a noisy transmission channel. In some cases, Tx power is adjusted based on rate, range, interference environment and propagation phenomenon to best meet overall mission needs for the waveform. In certain embodiments, navigation is one application of the present disclosure and the LPx parameters are adjusted or adapted to meet the navigation needs (e.g., ranging and communications of navigation parameters).

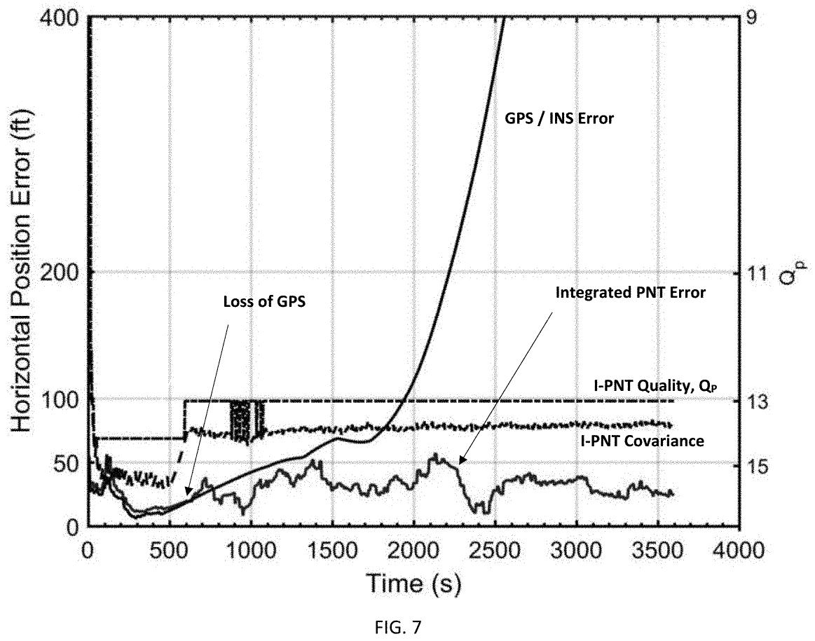

Referring to FIG. 7, a plot of the Integrated PNT geodetic position error is shown for a Link 16 networked embodiment of an integrated PNT solution in contrast to the typical GPS/INS position error for a platform when GPS jamming is present. The distributed PNT solution using the Link 16 network position reports (i.e., PPLIs) with TOAs maintains an accurate Integrated PNT solution in the absence of GPS according to the principles of the present disclosure. The loss of the GPS signal is noted at about 700 seconds. At that point, the horizontal position error greatly increases for a typical navigation system. In contrast, the horizontal position error for the integrated position, navigation, and timing (I-PNT) system of the present disclosure does not increase dramatically and in some cases even decreases over time. The I-PNT quality and I-PNT covariance is also plotted in the figure.

In certain embodiments, the accuracy of integrated or all-source PNT system in a GPS-denied environment is dependent on several factors including the accuracy of the time reference on each platform. For a given set of conditions (e.g., a clock that is on the higher end of the performance curve offering sub-nanosecond accuracy) the integrated or all-source PNT system could provide the navigation errors described herein. Certain embodiments of the integrated or all-source PNT system of the present disclosure can provide a 25-foot horizontal positioning error, 50-foot altitude error, and a 0.2 feet/sec velocity error. The integrated or all-source PNT can provide an order of magnitude improvement (0.1 Knots) over a typical INS (1.0 Knots) when GPS is not available.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claims refers to “a” or “an” element, that does not mean there is only one element. If the specification or claims refer to “an additional” element, that does not preclude there being more than one of the additional elements.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A system for integrated position, navigation, and timing, comprising:
a common time reference architecture;
an integrated dual-grid navigation module;
an integrated dual-grid navigation Kalman Filter; and
an integrated dual-grid navigation source selection module,
wherein the system is configured to provide both absolute geodetic and relative grid time and/or location information to a plurality of platforms in a network via a platform distributed position, navigation, and timing system and a communications system.

2. The system according to claim 1, wherein the system is functional in GPS denied and GPS degraded environments.

3. The system according to claim 1, wherein the common time reference architecture comprises a high precision time and frequency system.

4. The system according to claim 1, wherein the system provides a local airborne, shipboard, or ground-based solution.

5. The system according to claim 4, wherein the communication system provides for distribution of the position, navigation, and timing solution to other platforms in the network.

6. The system according to claim 1, wherein inputs to the system include data from primary navigation sensors and secondary navigation sensors, and primary navigation measurement sources and secondary navigation measurement sources.

7. The system according to claim 6, wherein the primary navigation sensors include an inertial navigation system (INS).

8. The system according to claim 6, wherein the primary navigation measurement sources include GPS.

9. The system according to claim 1, further comprising the use of an LPD/LPI/LPE (low probability of detection, intercept, or exploitation, respectively) navigation waveform with the communication system.

10. The system according to claim 1, wherein the integrated dual-grid navigation source selection module in connection with the integrated dual-grid navigation Kalman Filter determines, from all available navigation measurement sources, measurements that provide the best geometric distribution and minimum covariance for both geodetic and relative grid processing.

11. A method of integrated position, navigation, and timing, comprising:
receiving navigation sensor and navigation measurement source data from both local platform data and remote communication network data via an integrated position, navigation, and timing system, the system comprising:
a common time reference architecture;
an integrated dual-grid navigation module;
an integrated dual-grid navigation Kalman Filter; and
an integrated dual-grid navigation source selection module;
determining from all available navigation sensor data and navigation measurement sources, which sensor data and which measurement sources provide the best geometric distribution and minimum covariance for both geodetic and relative grid processing;
providing a local airborne, shipboard, or ground-based solution via a platform distributed position, navigation, and timing module; and
distributing the platform position, navigation, and timing solution to other platforms in the network via a communications system;
thereby providing relative time and/or location information to a plurality of platforms in a network in GPS denied and GPS degraded environments.

12. The method according to claim 11, wherein the common time reference architecture comprises a high precision time and frequency system.

13. The method according to claim 11, wherein the system provides a local airborne, shipboard, or ground-based solution.

14. The method according to claim 13, wherein the communication system provides for distribution of the position, navigation, and timing solution to other platforms in the network.

15. The method according to claim 11, wherein inputs to the system include data from primary navigation sensors and secondary navigation sensors, and primary navigation measurement sources and secondary navigation measurement sources.

16. The method according to claim 15, wherein the primary navigation sensors include INS and the primary navigation measurement sources include GPS.

17. The method according to claim 11, further comprising the use of an LPD/LPI/LPE (low probability of detection, intercept, or exploitation, respectively) navigation waveform with the communication system.

18. The method according to claim 11, wherein the integrated dual-grid navigation source selection module in connection with the integrated dual-grid navigation Kalman Filter determines, from all available navigation measurement sources, measurements that provide the best geometric distribution and minimum covariance for both geodetic and relative grid processing.

19. An integrated position, navigation, and timing system, comprising:
a common time reference architecture comprising a high precision time and frequency system;
an integrated dual-grid navigation module;
an integrated dual-grid navigation Kalman Filter; and
an integrated dual-grid navigation source selection module,
wherein the integrated position, navigation, and timing system is configured to provide both absolute geodetic and relative grid time and/or location information to a plurality of platforms in a network in GPS denied and GPS degraded environments via a platform distributed position, navigation, and timing system and a communications system.

20. The system according to claim 19, further comprising the use of an LPD/LPI/LPE (low probability of detection, intercept, or exploitation, respectively) navigation waveform with the communication system.
